(19) United States
(12) Patent Application Publication
(10) Pub. No.: US 2012/0027305 A1
(43) Pub. Date: Feb. 2, 2012

(54) APPARATUS TO PROVIDE GUIDE FOR AUGMENTED REALITY OBJECT RECOGNITION AND METHOD THEREOF

(75) Inventors: Mo-Hyun KIM, Seoul (KR); Seok-Jung PARK, Seoul (KR); Yong-Sik KIM, Seoul (KR); Han-Yeol KIM, Seoul (KR); Jeong-Won OH, Seoul (KR); Hyung-Chul LEE, Seoul (KR)

(73) Assignee: PANTECH CO., LTD., Seoul (KR)

(21) Appl. No.: 13/023,648

(22) Filed: Feb. 9, 2011

(30) Foreign Application Priority Data
Jul. 27, 2010 (KR) 10-2010-0072513

(51) Int. Cl. G06K 9/46; G06K 9/62

(52) U.S. Cl. 382/195; 382/181

(57) ABSTRACT

A method for providing a guide for augmented reality object recognition includes acquiring image information, analyzing an object corresponding to the image information, and outputting object recognition guide information according to a result of analyzing the object. An apparatus to provide a guide for augmented reality object recognition includes an image acquisition unit to acquire and output image information, and a control unit to analyze an object corresponding to the image information and to output object recognition guide information according to a result of analyzing the object.

### CROSS-REFERENCE TO RELATED APPLICATION

This application claims priority from and the benefit under 35 U.S.C. §119(a) of Korean Patent Application No. 10-2010-0072513, filed on Jul. 27, 2010, which is hereby incorporated by reference for all purposes as if fully set forth herein.

### BACKGROUND

### Field

The following disclosure relates to an apparatus to provide a guide for augmented reality object recognition and a method thereof, and more particularly, to an apparatus to recognize an object included in image information and to output a guide for object recognition, and a method thereof.

Discussion of the Background Augmented reality (AR) is a computer graphic scheme allowing a virtual object or information to be viewed as if the virtual object or information were in a real world environment by combining the virtual object or information with the real world environment. Thus, AR is a kind of Virtual Reality (VR) that provides images in which a real world viewed by users' eyes is merged with a virtual world providing additional information. The AR is similar to VR, but VR provides users with only virtual spaces and objects, whereas the AR synthesizes virtual objects based on a real world to provide additional information that cannot be easily provided in the real world. Unlike the VR based on a completely virtual world, the AR combines virtual objects with a real environment.

That is, unlike virtual reality, which is applicable only to limited fields such as computer games, AR is applicable to various types of real world environments and has been spotlighted as a next generation display technology for a ubiquitous environment.

For example, when a tourist on a street in London points a camera of a mobile phone having various types of functions, such as a Global Positioning System (GPS), information about a pub on the street or information about a shop having sale is overlaid with an image of the actual street and displayed to the tourist.

In order to provide augmented reality data, an object present in a real world is recognized. That is, a store or an object to obtain augmented reality data is recognized. According to one example of a method for recognizing an object, an object may be recognized from image information that is acquired by a camera.

However, the image from photographing the same object may be different depending on the distance between the object and the camera, the position of the camera, and/or the photographing angle of the camera. In order to recognize the object from different pieces of is image information, a processor may generate data of recognizing object image information according to a photographing state, in consideration of a variety of photographing states.

However, it is difficult to generate data of recognizing object image information according to all kinds of photographing states in practice. For this reason, in general, recognizable object image information is specified, and recognition is achieved only if a photographed object has information, such as shape, dimension, and color similar to the specified object image information, thereby lowering the performance of object recognition.

In addition, it is difficult for a user to know the specified object image information, so the user may try to continuously adjust the position of the camera, thereby causing inconvenience of use in object recognition.

### SUMMARY

Exemplary embodiments of the present invention provide an apparatus to provide augmented reality and method for providing a guide for augmented reality object recognition.

Additional features of the invention will be set forth in the description which follows, and in part will be apparent from the description, or may be learned by practice of the invention.

An exemplary embodiment of the present invention discloses a method for providing a guide for augmented reality object recognition. The method includes acquiring image information, analyzing an object corresponding to the image information, and outputting object recognition guide information according to a result of analyzing the object.

An exemplary embodiment of the present invention also discloses an apparatus to provide a guide for augmented reality object recognition. The apparatus includes an image is acquisition unit to acquire and output image information, and a control unit to analyze an object corresponding to the image information and to output object recognition guide information according to a result of analyzing of object.

An exemplary embodiment of the present invention also discloses a method for providing a guide for augmented reality object recognition. The method includes inputting image information, extracting first feature information corresponding to an object from the image information, retrieving second feature information from a storage, determining whether the first feature information corresponds to the second feature information, and outputting object recognition guide information according to a result of analyzing the object.

It is to be understood that both the foregoing general description and the following detailed description are exemplary and explanatory and are intended to provide further explanation of the invention as claimed. Other features will become apparent to those skilled in the art from the following detailed description, which, taken in conjunction with the attached drawings, discloses exemplary embodiments of the invention.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram illustrating an apparatus to provide a guide for augmented reality object recognition according to an exemplary embodiment.

FIG. 2 is a flowchart illustrating a method for providing a guide for augmented is reality object recognition according to an exemplary embodiment.

FIG. 3, FIG. 4, and FIG. 5 are views illustrating a method for guiding augmented reality object recognition according to an exemplary embodiment.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. Elements, features, and structures are denoted by the same reference numerals throughout the drawings and the detailed description, and the size and proportions of some elements may be exaggerated in the drawings for clarity and convenience.

Hereinafter, examples will be described with reference to accompanying drawings in more detail.

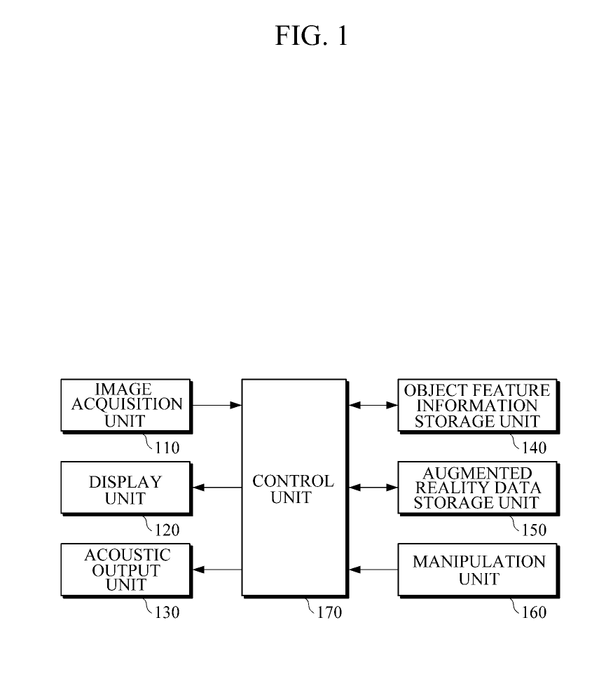

FIG. 1 is a block diagram illustrating an apparatus to provide a guide for augmented reality object recognition according to an exemplary embodiment.

As shown in FIG. 1, an apparatus to provide a guide for augmented reality object recognition includes an image acquisition unit 110, a display unit 120, an object feature information storage unit 140, and a control unit 170. In addition, the augmented reality object recognition guide providing apparatus may further include an acoustic output unit 130, an augmented reality data storage unit 150, and a manipulation unit 160. The apparatus may also include an antenna (not shown) and a radio frequency (RF) transceiver (not shown) to transmit and receive data via a network, such as a communication network.

The image acquisition unit 110 is configured to acquire an image and to output the acquired image to the control unit 170. The image acquisition unit 110 may be implemented by a camera or an image sensor, such as a complementary metal-oxide-semiconductor (CMOS) image sensor or a charge-coupled device (CCD). In addition, the image acquisition unit 110 may be implemented by a camera that can enlarge or reduce an acquired image through the control of the control unit 170 or can be rotatable in a manual or automatic manner. In addition, the image acquisition unit 110 may acquire an image having been previously photographed or transmitted through a communication interface (not shown) and output the acquired image. In addition, the image acquisition unit 110 may acquire an image stored in a memory and output the acquired image. The control unit 170 extracts feature information used to recognize an object from image information that is acquired by the image acquisition unit 110. For example, the feature information used to recognize an object may include an outline (edge line) and colors included in the image information.

The display unit 120 outputs image information, which may include an object, acquired by the image acquisition unit 110. The acoustic output unit 130 outputs information from the control unit 170 in the form of acoustic data. The control unit 170 controls the display unit 120 and/or the acoustic output unit 130 to output data corresponding to guide information for object recognition, a notification message indicating the ability to recognize an object, and/or augmented reality data related to the acquired object.

The object feature information storage unit 140 stores object feature information to identify an object recognized from image information. For example, the apparatus may not recognize an object “book” with outline data of the “book” obtained from image information is about the object “book.” For this reason, outline (edge) data may be previously stored, and the stored outline is compared with outline (edge) data input from the image information to recognize the object “book.” Hereinafter, for the sake of convenience in description, feature information of an object detected from image information is referred to as first feature information and feature information of the object stored in the object feature information storage unit 140 is referred to as second feature information. It will be understood that, although the terms first, second, etc. are used to describe information, these terms are only used to distinguish one type of information from another type of information.

The second feature information may be individual feature information of an object. In the case of a mobile terminal, which may have a limited memory, second feature information may be stored in an external server accessible through a network. The second feature information stored in the object feature information storage unit 140 or retrieved via the network may be common feature information that is extracted among one or more objects each having a similar or same attribute in common. This may improve the recognition performance by the mobile terminal. For example, the second feature information may allow an object to be recognized as a book having a title, such as “The Secrets of English Email,” or to be recognized just as a book. As an example, the second feature information may be a title of a book, such as “The Secrets of English Email,” or a rectangle corresponding to an outline (edge) of a general book. As another example, the second feature information may be a long face line, large eyes and thick lip lines specifying a person, or a pre-identified person, or may be information about the presence of an oval corresponding to a general outline of the face, eyes, a nose and a mouth of a human.

The augmented reality data storage unit 150 stores augmented reality data is corresponding to various types of information related to an object. As described above, the augmented reality data may be provided in an embedded form. Alternatively, the augmented reality data may be generated at an external place and then provided through a network and, in this case, the augmented reality object guide providing apparatus may further include a communication interface (not shown) enabling a network communication. As an example, if the object is a tree, the augmented reality data may be the name of the tree, main habitations of the tree, and ecological characteristics of the tree and represented in the form of a predetermined tag image.

The manipulation unit 160 corresponding to a user interface is used to receive information from a user. As an example, the manipulation unit 160 may include a keypad entry unit to generate key data if a key button is pushed, a touch screen, or a mouse. In addition, object related information may be input through the manipulation unit 160. For example, the manipulation unit 160 may receive information identifying an object of interest included in an acquired image, which may allow the second feature information to be more easily detected.

The control unit 170 controls the components that have been described above, and performs a guide operation for augmented reality object recognition. The control unit 170 may be implemented using a hardware processor or a software module executable on a hardware processor, or a combination thereof. More details of the operation of the control unit 170 will be described later through a method for guiding augmented reality object recognition.

The control unit 170 may include various types of sensors (not shown) to provide sensing information to help to detect an object in image information or to detect augmented reality data about the object detection. For example, the sensing information may include a present time, a present position, or a photographing direction of the image information, or may is include a time or position at which the image information was acquired or initially captured and stored.

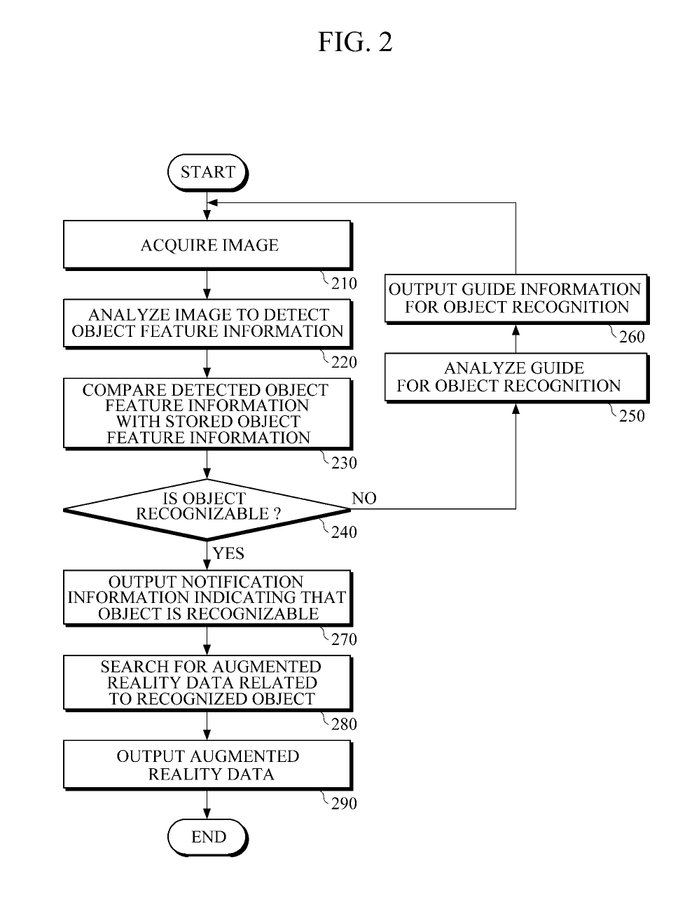

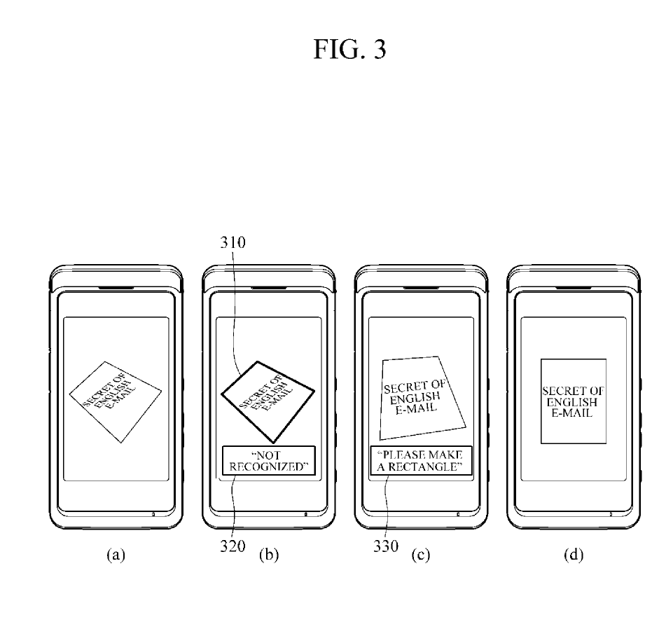

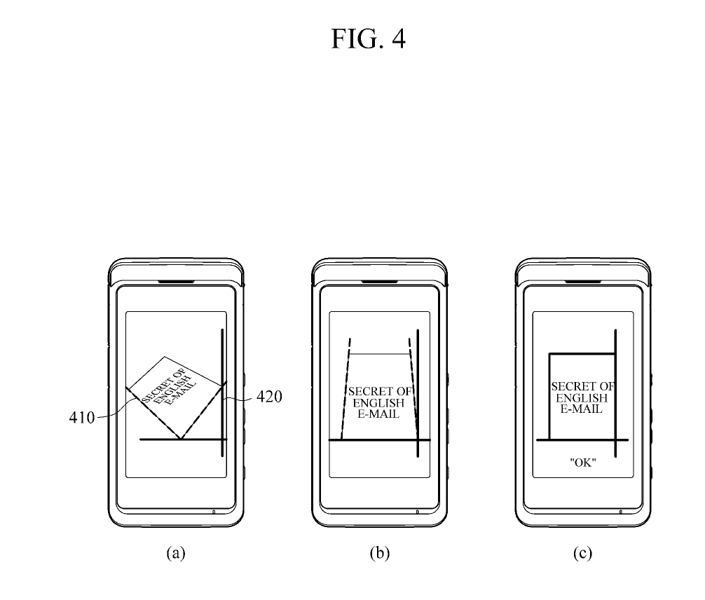

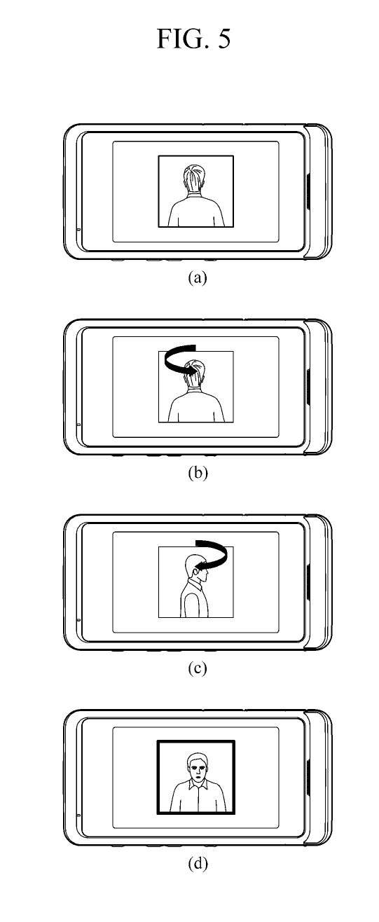

Hereinafter, a method for guiding augmented reality object recognition in the apparatus for providing a guide for augmented reality object recognition will be described in more detail with reference to FIG. 2, FIG. 3, FIG. 4, and FIG. 5. FIG. 2 is a flowchart illustrating a method for providing a guide for augmented reality object recognition according to an exemplary embodiment. FIG. 3, FIG. 4, and FIG. 5 are views illustrating a method for guiding augmented reality object recognition according to an exemplary embodiment.

As shown in FIG. 2, if an object recognition mode is set by a key entry of a user, the control unit 170 operates the image acquisition unit 110 to acquire image information including at least one object (210). Then, the control unit 170 extracts first feature information for object recognition from the acquired image information (220).

As described above, an example of the first feature information may include outline (edge) information of an object depending on the degree of a change in brightness of the image information. The first feature information may be provided similar to a pencil drawing. Another example of the first feature information may be saturation information of the image information. For example, if image information corresponds to the face of a human, the first feature information may be a color corresponding to a human face color.

The control unit 170 compares the first feature information with the second feature information, which may be previously stored in the object feature information storage unit 140 or retrieved via a network (230).

As an example, the control unit 170 may detect second feature information similar to the first feature information from among the second feature information, and compares the is first feature information with the detected second feature information. If the image information includes an outline of a rear view of a human and the first feature information is an outline (edge) of a human, the control unit 170 may detect feature information similar to the rear view outline of a human among the second feature information. For example, an outline (edge) of a front view of a human including a facial structure outline may be detected as second feature information and compared with the rear view outline of a human included in the image information.

As another example, the control unit 170 may receive information identifying an object of interest through the manipulation unit 160 by a user, and detects second feature information corresponding to the received information. The control unit 170 compares the detected second feature information with the first feature information. For example, if a user inputs information indicating that an object of interest is a book, the control unit 170 compares a rectangular outline of a book, that is, second feature information about a book stored in the object feature information storage unit 140, with an outline of a book detected from the image information.

As another example, the control unit 170 may estimate the type of an object of interest from image information, and detects second feature information of the estimated type. The control unit 170 compares the detected second feature information with first feature information. For example, geometric features, such as a vertical line, a horizontal line, and an intersection are found among possible outlines (edges) in the image information, and the relationship among the found geometric features is recognized, thereby estimating the type of an object of interest. That is, if the first feature information is estimated to include an outline (edge) of a building and an outline of a sign board, the control unit 170 detects a rectangle, that is, an is outline (edge) of a sign board, which is stored or retrieved as second feature information. The control unit 170 compares the detected second feature information with first feature information.

Thereafter, the control unit 170 determines whether object recognition is possible from the image information using the result of operation 230 (240).

As one example, as shown in (b) of FIG. 3, when an outline 310 serving as first feature information is detected from image information corresponding to a book entitled “The Secrets of English Email” shown in (a) of FIG. 3, second feature information, which may be previously stored corresponding to an object classified as a book, may be a rectangular outline shown in (d) of FIG. 3. In this case, the outline 310 shown in (b) of FIG. 3 is not a rectangular outline shown in (d) of FIG. 3, so the control unit 170 determines that the object is not recognizable. As another example, as shown in FIG. 5, when an upper body outline is detected as first feature information from the image information (a), if second feature information, which has been previously stored corresponding to an object classified as a human, is the upper body outline and the facial structure of a human, it is determined that the object is not recognizable from the image information (a). As another example, if the object is significantly small or the object is photographed in a dark place, it may be determined that the object is not recognized.

As a result of operation 240, if it is determined that the object is not recognizable, the control unit 170 analyzes an object recognition guide (250). That is, in the analyzing of object recognition guide, the first feature information extracted from the image information is compared with the previously stored or retrieved second object feature information to analyze the angle between the object and a camera, the distance between the object and the photographing position, and/or the photographing direction of the object. As a result, the position of the camera or the position of the object to be adjusted is determined.

As one example, the analyzing of the object recognition guide may produce a result that an outline of a book is tilted as shown in (a) of FIG. 3 compared to the second feature information and thus the object may be adjusted to move to the center of the screen or the camera may be adjusted to photograph the object at a lower position. As another example, the analyzing of the object recognition guide may produce a result that feature information of a human included in the image information shown in (a) of FIG. 5 includes an outline of a human except for a facial structure. As such, the feature information is regarded as a rear view of a human and thus the object may be adjusted to turn 180 degrees for recognition. As another example, although not shown, if the face of a human is not provided horizontally, the analyzing of the object recognition guide produces a result that the face may be adjusted by being provided horizontally. That is, the position of eyes on the face is recognized, and the angle formed by eyes is calculated through the position information of the recognized position of eyes. A method of recognizing the position of eyes on the face is achieved through comprehensive information including the movement of eye balls, the color difference of the face and eyes, a general shape of eyes and the position of eyes on the face.

The control unit 170 generates a photographing guide enabling object recognition according to the result of analyzing (260).

For example, as shown in (a) of FIG. 4, a recognizable guide line 420 is displayed on the display unit 120 with an outline 410 of the image information, thereby helping a user to adjust the position of the camera to match the object to the recognizable guide line 420, such as shown in (b) of FIG. 4. The recognizable guide line 420 may overlap with an outline 410 of the image information. As an example, as shown in (c) of FIG. 3, guide information 330 may be provided on the display screen in the form of a pop-up message. As another example, the control is unit 170 may control guide information sound such as an instruction to a user to be output through the acoustic output unit 130 while outputting guide information on the display unit 120 or separately from outputting guide information on the display unit 120. Further, the guide information 330 may display as a pop-up menu offering a user an option to take other steps, such as capture an image, call a number or send a message for help with matching the object, or to select a different outline or object appearing in the image information, such as if the image information shows more than one object and the guide line 420 is being shown for an object other than the desired object in the image.

Then, the user may acquire a recognizable object image while photographing the object at a photographing position such that the first feature information corresponds to the second feature information. In this case, the control unit 170 may allow the camera to rotate or perform a zoom in/zoom out operation automatically or upon a request by a user.

As a result of operation 240, if it is determined that the object is recognizable from the image information, the control unit 170 outputs notification information indicating the object is recognizable (270). For example, after adjusting the object or camera as shown in (b) or (c) of FIG. 5, then as shown in (d) of FIG. 5, as a visual method, the outline of the object may be displayed in a distinguishable color or in a bold outline line. As another example, as shown in (c) of FIG. 4, a pop-up message “OK” may be displayed to indicate that the object is recognizable. As another example, as an aural indication to indicate that the object is recognizable, a preset beep sound may be an output or previously stored sound source denoting “recognizable” may be output. These are merely examples, and the method for indicating that the object is recognizable is not limited thereto.

The control unit 170 searches for augmented reality data related to the recognized is object in the augmented reality data storage unit 150 (280). Information related to the object may be obtained from a Global Positioning System (GPS). The control unit 170 outputs augmented reality data related to the object to the user through the display unit 120 or the acoustic output unit 130 (290).

The disclosure can be embodied as computer-readable codes on a computer-readable recording medium. The computer-readable recording medium may be a data storage device that can store data which can be thereafter read by a computer system.

Examples of the computer-readable recording medium include read-only memory (ROM), random-access memory (RAM), CD-ROMs, magnetic tapes, floppy disks, optical data storage devices, and carrier waves such as data transmission through the Internet. The computer-readable recording medium can also be distributed over a network coupled to computer systems so that the computer-readable code is stored and executed in a distributed fashion.

Also, functional programs, codes, and code segments for accomplishing the embodiments of the present invention can be generated by programmers skilled in the art to which the invention pertains. A number of exemplary embodiments have been described above. Nevertheless, it will be understood that various modifications may be made. For example, the disclosure may be met if the described techniques are performed in a different order and/or if components in a described system, architecture, device, or circuit are combined in a different manner and/or replaced or supplemented by other components or their equivalents. Accordingly, other implementations are within the scope of the following claims and their equivalents.

Thus, it is intended that the present invention cover the modifications and variations of this invention provided they come within the scope of the appended claims and their equivalents

What is claimed is:

1. A method for providing a guide for augmented reality object recognition, comprising:
acquiring image information;
analyzing an object corresponding to the image information; and
outputting object recognition guide information according to a result of analyzing the object.

2. The method of claim 1, wherein outputting the object recognition guide information comprises indicating that the object is not recognizable from the image information.

3. The method of claim 1, wherein analyzing the object comprises:
extracting first feature information corresponding to the object from the image information;
comparing the first feature information with second feature information for object recognition; and
determining whether the first feature information corresponds to the second feature information.

4. The method of claim 3, wherein the first feature information comprises an edge line or color of the object.

5. The method of claim 3, wherein the second feature information represents feature information extracted from one or more object having a corresponding attribute.

6. The method of claim 3, wherein the comparing further comprises:
receiving object information from a user to detect second feature information corresponding to the object information.

7. The method of claim 1, wherein outputting the object recognition guide information further comprises displaying stored feature information with the image information.

8. The method of claim 1, wherein outputting the object recognition guide information further comprises displaying a pop-up message on a screen.

9. The method of claim 1, wherein outputting the object recognition guide information further comprises emitting acoustic data.

10. The method of claim 1, further comprising:
outputting information indicating that the object is recognizable,
wherein the information indicating that the object is recognizable comprises a display message displayed on a screen or emitted acoustic data.

11. The method of claim 1, further comprising:
displaying an outline of the object in a predetermined color to indicate that the object is recognizable.

12. An apparatus to provide a guide for augmented reality object recognition, comprising:
an image acquisition unit to acquire and output image information; and
a control unit to analyze an object corresponding to the image information and to output object recognition guide information according to a result of analyzing the object.

13. The apparatus of claim 12, further comprising:
an object feature information storage unit to store second feature information for object recognition,
wherein the control unit extracts first feature information corresponding to the object from the image information, and compares the first feature information with the second feature information to determine whether the first feature information corresponds to the second feature information.

14. The apparatus of claim 12, wherein the control unit generates photographing guide information for object recognition if the object is not recognizable.

15. The apparatus of claim 14, further comprising:
a display unit to display data,
wherein the control unit outputs the photographing guide information to the display unit to be displayed with the image information.

16. The apparatus of claim 14, further comprising:
a display unit to display data,
wherein the control unit outputs the photographing guide information, and the display unit displays the photographing guide information as a pop-up message.

17. The apparatus of claim 11, further comprising:
an acoustic data output unit to emit sound data,
wherein the control unit outputs the object recognition guide information to the acoustic data output unit, and the acoustic data output unit emits sound data corresponding to the object recognition guide information in the form of an audible instruction.

18. A method for providing a guide for augmented reality object recognition, comprising:
inputting image information;
extracting first feature information corresponding to an object from the image information;
retrieving second feature information from a storage;
determining whether the first feature information corresponds to the second feature information; and
outputting object recognition guide information according to a result of analyzing the object.

19. The method of claim 18, wherein the second feature information is retrieved from an external server via a communication network.
